(19) United States
(12) Patent Application Publication
(10) Pub. No.: US 2025/0365655 A1
(43) Pub. Date: Nov. 27, 2025

(54) METHOD AND APPARATUS FOR SELECTION OF NETWORK SUPPORTING ENERGY CONTROL IN WIRELESS COMMUNICATION SYSTEM

(71) Applicant: Samsung Electronics Co., Ltd., Gyeonggi-do (KR)

(72) Inventors: Dongeun SUH, Gyeonggi-do (KR); Jungshin PARK, Gyeonggi-do (KR); Hoyeon LEE, Gyeonggi-do (KR)

(21) Appl. No.: 19/217,011

(22) Filed: May 23, 2025

(30) Foreign Application Priority Data
May 24, 2024 (KR) 10-2024-0068060

(51) Int. Cl. H04W 48/18

(52) U.S. Cl. CPC H04W 48/18

(57) ABSTRACT

Disclosed is a method and apparatus for selecting a network that supports energy control in a wireless communication system. A method performed by a policy control function (PCF) in a wireless communication system that supports energy control may include receiving, from a unified data repository (UDR), a first message including user plane (UP) requirement information related to the energy control and provided from an application function (AF), identifying whether indication information related to the energy control is included in the UP requirement information, in case that the indication information is included in the UP requirement information, identifying whether network slice related information required for the energy control for a user equipment (UE) that uses a service exists, and in case that the network slice related information does not exist, obtaining the network slice related information required for the energy control for the service.

### CROSS-REFERENCE TO RELATED APPLICATION(S)

This application is based on and claims priority under 35 U.S.C. § 119 to Korean Patent Application No. 10-2024-0068060, filed on May 24, 2024, in the Korean Intellectual Property Office, the disclosure of which is incorporated herein by reference in its entirety.

### BACKGROUND

### 1. Field

The disclosure relates generally to a wireless communication system, and more particularly, to a method and apparatus for selecting a network that supports energy control in a wireless communication system.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

3^{rd} generation partnership project (3GPP), which directs the cellular mobile communication standard has named a new core network (CN) structure “5G core (5GC)” and has proceeded with standardization to enable the migration of legacy 4th generation (4G) long term evolution (LTE) systems to 5G systems. The 5GC supports differentiated functions as compared with an evolved packet core (EPC), which is a network core for the legacy 4G.

The 5GC introduces a network slice function. As the requirements of the 5G system, the 5GC may support various UE types and services, such as eMBB, URLLC, and mMTC. The UE/services have different requirements from the CN. For example, the eMBB service requires a high data rate, and the URLLC service requires high reliability and low latency. The network slice technology is provided to satisfy these various service requirements. However, there is a need in the art for a method and apparatus to efficiently select a network that supports energy control in a wireless communication system.

### SUMMARY

The disclosure has been made to address at least the above-mentioned problems and/or disadvantages and to provide at least the advantages described below.

Accordingly, an aspect of the disclosure is to provide a method and apparatus for efficiently selecting a network that supports energy control in a wireless communication system.

An aspect of the disclosure is to provide a method and apparatus for efficiently selecting/allocating a network slice and/or network for supporting energy control in a wireless communication system.

An aspect of the disclosure is to provide a method and apparatus for efficiently signaling a dedicated network slice and/or dedicated data name network (DNN) required for supporting energy control in a wireless communication system.

In accordance with an aspect of the disclosure, a method performed by a policy control function (PCF) in a wireless communication system that supports energy control may include receiving, from a unified data repository (UDR), a first message including user plane (UP) requirement information related to the energy control and provided from an application function (AF), identifying whether indication information related to the energy control is included in the UP requirement information, identifying whether network slice related information required for the energy control for a UE that uses a service exists when the indication information is included in the UP requirement information, and obtaining the network slice related information required for the energy control for the service when the network slice related information does not exist.

In accordance with an aspect of the disclosure, a PCF in a wireless communication system that supports energy control may include a transceiver and a processor configured to receive, from a UDR, via the transceiver, a first message including UP requirement information related to the energy control and provided from an AF, identify whether indication information related to the energy control is included in the UP requirement information, identify whether network slice related information required for the energy control for a UE that uses a service exists when the indication information is included in the UP requirement information, and obtain the network slice related information required for the energy control for the service when the network slice related information does not exist.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates an example of a network structure for a 5G system to which the disclosure is applied;

FIGS. 2A and 2B illustrate a procedure that selects/allocates/determines a network supporting energy control in a wireless communication system according to an embodiment;

FIGS. 3A and 3B illustrate a procedure that selects/allocates/determines a network supporting energy control in a wireless communication system according to an embodiment;

FIG. 4 illustrates an energy monitoring session request method based on UE configuration information in a wireless communication system that supports energy control according to an embodiment; and

FIG. 5 illustrates a structure of a network entity in a wireless communication system according to an embodiment.

### DETAILED DESCRIPTION

Hereinafter, embodiments of the disclosure will be described in detail in conjunction with the accompanying drawings. A detailed description of known functions or configurations that may make the subject matter of the disclosure unclear will be omitted for the sake of clarity and conciseness.

The terms which will be described below are terms defined in consideration of the functions in the disclosure, and may be different according to users, intentions of the users, or customs. Therefore, the definitions of the terms should be made based on the contents throughout the specification.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure. Throughout the specification, the same or like reference signs indicate the same or like elements.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

Herein, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the disclosure, terms for identifying access nodes and referring to network entities, messages, interfaces between network entities, various identification information, and the like are illustratively used for the sake of descriptive convenience. Therefore, the disclosure is not limited by the terms as described below, and other terms referring to subjects having equivalent technical meanings may also be used.

Furthermore, terms and names defined in 5GS and NR standards, which are the standards specified by the 3GPP group among the existing communication standards, will be used for the sake of descriptive convenience. However, the disclosure is not limited by these terms and names, and may be similarly applied to systems that conform to other standards. The disclosure may be applied to the 3GPP 5GS/NR (5th generation mobile communication standards).

In the following description, a base station (BS) allocates resources to UEs, and may be at least one of an eNode B, a Node B, a radio access network (RAN), an access network (AN), a RAN node, a wireless access unit, a BS controller, and a node on a network. A user equipment (UE) may be at least one of a terminal, a mobile station (MS), a cellular phone, a smartphone, a computer, or a multimedia system capable of performing a communication function. A “downlink (DL)” refers to a radio link via which a BS transmits a signal to a UE, and an “uplink (UL)” refers to a radio link via which a UE transmits a signal to a BS. LTE or LTE-A systems may be described by way of example, but the embodiments of the disclosure may also be applied to other communication systems having similar technical backgrounds or channel types. Furthermore, based on determinations by those skilled in the art, the embodiments of the disclosure may also be applied to other communication systems through some modifications without significantly departing from the scope of the disclosure.

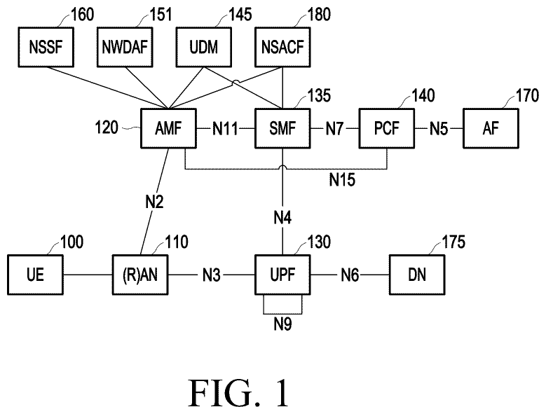

In the disclosure, network technology may refer to the standard specifications defined by the International Telecommunication Union (ITU) or 3GPP. The components included in the network structure of FIG. 1 described below may be physical entities, software performing individual functions, or hardware combined with software. The reference numerals N1, N2, N3, . . . , Nxxx, and the like in drawings are the publicly known interfaces between NFs in the 5G CN.

In 3GPP systems, conceptual links connecting NFs in the 5G system are defined as reference points. Examples of reference points included in the 5G system architecture described in FIG. 1 are provided below.
N1 is a reference point between a UE and an access and mobility management function (AMF)
N2 is a reference point between an (R)AN and an AMF
N3 is a reference point between an (R)AN and a user plane function (UPF)
N4 is a reference point between a session management function (SMF) and a UPF
N5 is a reference point between a PCF and an AF
N6 is a reference point between a UPF and a data network (DN)
N7 is a reference point between an SMF and a PCF
N8 is a reference point between a user data management (UDM) and an AMF
N9 is a reference point between two core UPFs
N10 is a reference point between a UDM and an SMF
N11 is a reference point between an AMF and an SMF
N12 is a reference point between an AMF and an authentication server function (AUSF)
N13 is a reference point between a UDM and an AUSF
N14 is a reference point between two AMFs
N15 is a reference point between a PCF and an AMF for a non-roaming scenario, and a reference point between a PCF and an AMF in a visited network for a roaming scenario

FIG. 1 illustrates an example of a network structure for a 5G system to which the disclosure is applied. Referring to FIG. 1, the 5G system may include a 5GC having a BS 110, and a UE 100. The 5GC may include as an AMF 120 that manages mobility of the UE 100, an SMF 135 that manages a session, a UPF 130 connected to a DN 175 and performs data transmission, a network slice selection function (NSSF) (not illustrated) that selects a network slice providing a service to the UE 100, an AUSF that authenticate a network entity (entities) in the 5G system, a network exposure function (NEF) (not illustrated) that transfers or receive an event occurring in the 5G system and a supporting capability to/from the outside, a network repository function (NRF) that manages registration information of NFs, a PCF 140 that provides a PCF of a network operator, a UDM 145 that provides a data management function such as subscriber data and policy control data, or the like, a UDR (not illustrated) that stores data of various NFs, a network data analytic function (NWDAF) 151, a network slice admission control function (NSACF) 180, or the like, and an AF 170 that provides an application service may communicate with the 5GC.

The AMF 120 manages access and mobility of the UE 100. For example, the AMF 120 may perform a network function such as registration, connection, reachability, mobility management, access verification, authentication, or mobility event generation in association with the UE 100. The SMF 135 may perform a management function associated with a PDU session of the UE 100. For example, the SMF 135 may perform a session management function, such as session establishment, modification, release, and maintaining a tunnel between the UPF 130 and the BS (RAN) 110, an Internet protocol (IP) address allocation and management function associated with an IP of the UE 100, and a network function such as UP selection and control, or the like. The UPF 130 may perform a data processing function that delivers data obtained from the UE 100 to the DN 175 that is an external network, or delivers data obtained from the DN 175 to the UE 100. In addition, the UPF 130 may perform a network function such as acting as an anchor between radio access technologies (RATs), providing a connection between a PDU session and the AF 170, packet routing and forwarding, packet inspection, applying a UP policy, creating a traffic usage report, buffering, or the like. The PCF 140 may manage operator policy information for providing a service in the 5G system, and the UDM 145 may perform a function such as generating authentication information for 3GPP security, managing a list of NFs that support the UE 100, managing subscription information, and the like. The 5G system supports technology called a session and service continuity (SSC) mode that supports session continuity for the purpose of improving a UE's quality-of-experience (QoE) or supporting a mission critical service.

In FIG. 1, when the UE 100 registers with a network, the UE 100 may transmit, to the AMF 120, identification information referred to as single-network slice selection assistance information (S-NSSAI) information associated with network slices that the UE 100 is to request, and the AMF 120 may provide, to the UE 100, information (allowed NSSAI) associated with a network slice that is allowed for the UE 100 in consideration of the requested S-NSSAIs, subscription information, and the like. To perform data transmission or reception to a predetermined DN 175 via the allowed network slice(s) (allowed NSSAI(s)), the UE 100 may select one of the allowed network slices, may request establishment of a PDU session to a DNN associated with the corresponding network slice, and may perform data transmission or reception via the established PDU session.

In the 5G system, network slicing technology is the technology and structure that enable various virtualized and independent logical networks in a single physical network. To satisfy specified requirements of a service/application, a network operator may configure a virtual end-to-end network referred to as the network slice, which is identified by the S-NSSAI called. In a UE registration procedure, the network may transmit an allowed slice set (e.g., allowed NSSAI(s)) to a UE, and the UE may perform application data transmission or reception via a protocol data unit (PDU) session established based on S-NSSAI. Hereinafter, operation of an NF may be understood as an operation of an orchestration and management (OAM).

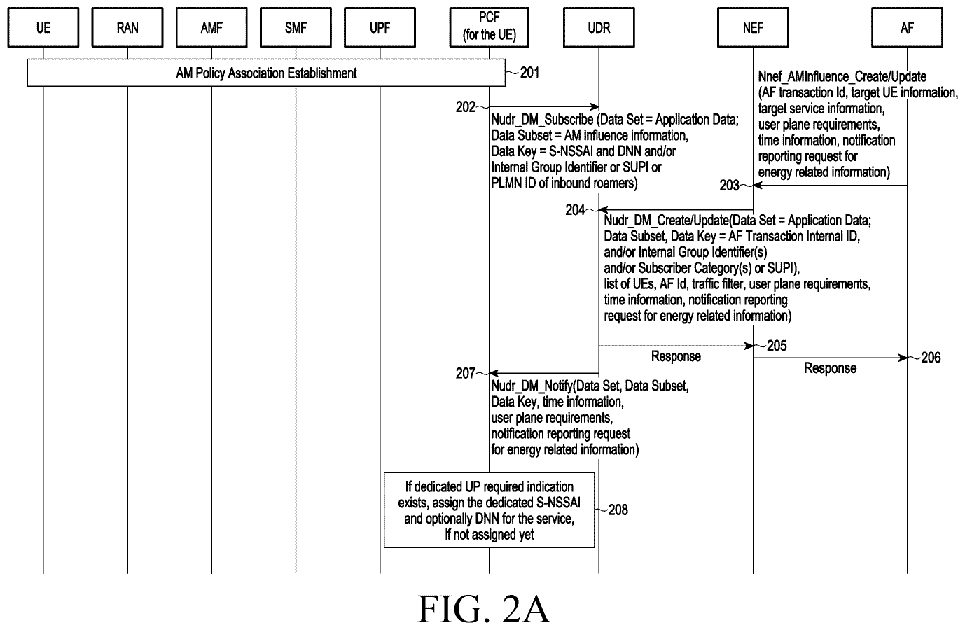

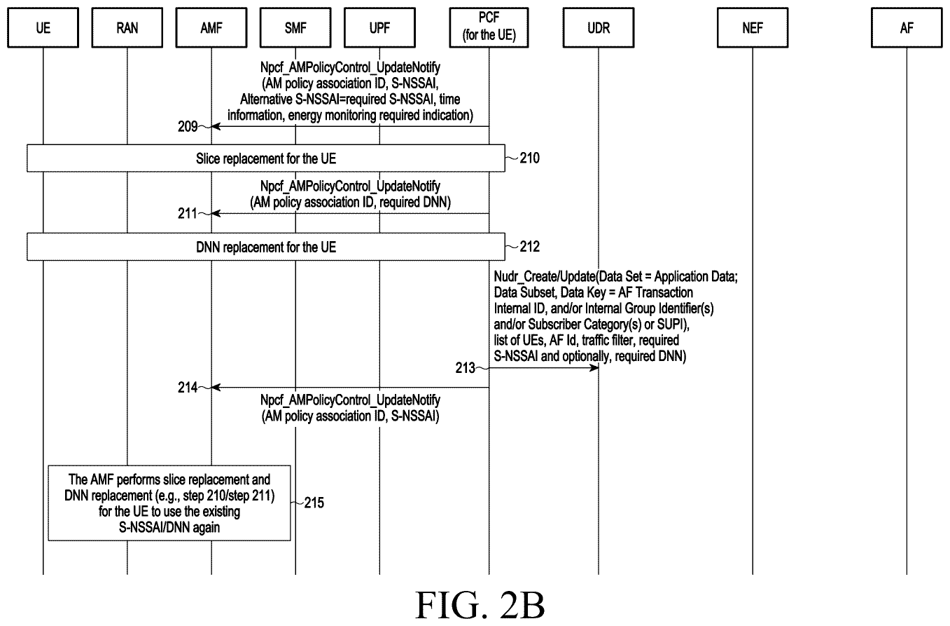

FIGS. 2A and 2B illustrate a procedure that selects/allocates/determines a network supporting energy control in a wireless communication system according to an embodiment. FIG. 2A and FIG. 2B include a method in which an AF provides, to an AMF via a PCF, UP requirements associated with a UE(s) that uses a service requiring energy control.

Referring to FIG. 2A, in step 201, the AMF may perform AM policy association establishment with the PCF. The AMF may obtain access control and mobility management related policies (AM policy) associated with the UE from the PCF via the AM policy association establishment.

In step 202, the PCF may transmit, to a UDR, a subscription request message for subscribing (subscription) to application data stored in the UDR in association with a predetermined service (or application) or predetermined UE(s). The subscription request message may include at least one piece of information from among a data set, a data subset, and a data key as described below, and each information may be configured as follows.

A data key may be configured as an S-NSSAI and/or DNN indicating a predetermined service, or may be configured as identifier information associated with a UE(s) that uses a predetermined service (internal group identifier, subscription permanent identifier (SUPI), or public land mobile network (PLMN) ID of inbound roamers).

A data set may be configured as application data.

A data subset may be configured as AM influence information.

A data key may be configured as an S-NSSAI and DNN and/or internal group identifier or SUPI or PLMN ID of inbound roamers or any UE.

In step 203, the AF may transmit, to an NEF, a message including requirement information associated with a UP for a UE(s) that uses a predetermined service (or application) or a predetermined UE(s). The message (or Nnef_AMInfluence_Create/Update message) including the requirement (request) information may include at least one from among the following information.

AF transaction Id indicates a transaction identifier for the corresponding request.

Target UE information includes information indicating a UE(s) to which the corresponding request is to be applied. The corresponding information may include at least one from among a generic a public subscription identifier(s) (GPSI(s)), a SUPI(s), an external group identifier, an internal group identifier, a PLMN ID, and any UE.

Target service information includes information indicating a service (or application) to which the corresponding request is to be applied. The information indicating the service (or application) that is subjected to the application may include one or more of an external application identifier, an application service provider (ASP) ID, an AF Id, an S-NSSAI/DNN, or a traffic filter.

UP requirements are associated with an object. The UP requirements may include a dedicated UP required indication (or energy monitoring required indication), or an energy saving required indication. The dedicated UP required indication (or energy monitoring required indication) may be an indicator requesting that a corresponding traffic be serviced by a UP (i.e., dedicated UP) that uses the corresponding traffic. The energy saving required indication may include an indicator indicating that a corresponding traffic is to be subjected to energy saving. Alternatively, the dedicated UP required indication (or energy monitoring required indication), together with the energy saving required indication, may be included in the UP requirements.

Time information includes time information at which information included in the requirements is to be applied.

Notification reporting request for energy related information includes address information (e.g., fully qualified domain name (FQDN)), IP address/port number, or the like) for receiving a notification message associated with energy-related information.

In step 204, when the NEF receives the request message of step 203 from the AF, the NEF may transmit, to the UDR, a message (or Nudr_DM_Create/Update message) including at least one from among the following information to store, in the UDR, the information included in the request message received from the AF. The message of operation 204 may include at least one from among a data set, a data subset, a data key, and information to be stored for the corresponding key, and each information may be configured as follows.

A data set may be configured as application data.

A data subset may be configured as AM influence information.

A data key may be configured as an S-NSSAI and DNN and/or internal group identifier or SUPI or PLMN ID of inbound roamers or any UE.

When the target service information of step 203 includes an AF ID or ASP ID, instead of an S-NSSAI/DNN, the NEF may acquire an S-NSSAI/DNN corresponding to the AF ID or ASP ID based on configuration information that may be used for the data key.

The data key may be configured as an AF transaction internal ID, and/or internal group identifier(s) and/or subscriber category(s) or SUPI.

The data key may include AF Id,
target service information, UP requirements, time information, and notification reporting request for energy related information. (e.g., energy consumption, energy efficiency, or the like)

In step 205, when the UDR receives the message of operation 204 and is successfully store the same, the UDR may transmit a response message to the NEF.

In step 206, when the NEF receives, from the UDR, the response message of operation 205, including a processing result associated with the request message of operation 204, the NEF may transmit a response message including the processing result to the AF in response to step 203.

In step 207, when a PCF(s) that subscribes to updated application data exists, the UDR may transmit a message (or Nudr_DM_Notify message) notifying the same to the corresponding PCF(s). The message of step 207 may include parameters (information(s)) (or newly stored parameters) changed/configured in step 204.

In step 208, when the received notification message of step 207 includes a dedicated UP indication, and also when a dedicated S-NSSAI and/or dedicated DNN which is being used for an S-NSSAI and/or DNN (i.e., for the corresponding service) included in the notification message of step 207 does not exist, the PCF may determine/allocate a dedicated S-NSSAI and/or dedicated DNN for the S-NSSAI and/or DNN included in the notification message of step 207. Herein, the dedicated S-NSSAI and the dedicated DNN may have the same meanings as a required S-NSSAI and a required DNN, respectively, and may be interchangeably used.

Alternatively in FIG. 2A, the PCF may perform signaling with the UDR and may identify whether the dedicated S-NSSAI and/or dedicated DNN exist. When a dedicated S-NSSAI and/or dedicated DNN, allocated previously, exists, the PCF may use the previously allocated dedicated S-NSSAI and/or dedicated DNN.

In step 208, when the received notification message of step 207 includes an energy monitoring required indication, and when a dedicated S-NSSAI and/or dedicated DNN which is being used for an S-NSSAI and/or DNN (i.e., for the corresponding service) included in the notification message of step 207 does not exist (that is, if the dedicated S-NSSAI and/or the dedicated DNN for the service does not assigned yet), the PCF may determine/allocate a dedicated S-NSSAI and/or dedicated DNN for the S-NSSAI and/or DNN included in the notification message of step 207.

In in step 208, when the received notification message of step 207 includes an energy saving required indication, and when an S-NSSAI and/or DNN (i.e., the corresponding service) included in the notification message of step 207 is not an S-NSSAI that supports energy saving or energy control and/or DNN that supports energy saving or energy control, the PCF may determine/allocate an S-NSSAI for energy saving and/or DNN for energy saving for the S-NSSAI and/or DNN included in the notification message of step 207.

In addition, when a UE(s) that has yet to use a dedicated S-NSSAI among the UEs that currently use the corresponding service, the PCF may perform a procedure of changing an S-NSSAI of the UE that has yet to use a dedicated S-NSSAI to a dedicated S-NSSAI.

Referring to FIG. 2B, in step 209, when a UE that has yet to change to a dedicated S-NSSAI exists among the UEs that use the S-NSSAI received in step 207, the PCF may transmit, to the AMF, a message (or Npcf_AMPolicyControl_UpdateNotify message) for changing to the dedicated S-NSSAI determined/allocated in step 208.

When the message of step 207 includes the time information, the PCF may start a timer configured to an expiration time included in the time information.

The message of step 209 may include at least one from among the following information.

AM policy association ID may include an identifier of an AM policy.

S-NSSAI is a network slice identifier to be changed, and may include an S-NSSAI for a service included in UP requirements.

Alternative S-NSSAI is an alternative network slice identifier, and may include a dedicated S-NSSAI (or required S-NSSAI) allocated for a service including UP requirements.

Time information concerning when a policy needs to be applied to a service is included in the notification message of step 207. The corresponding time information may be transmitted in the form of a timer.

Energy monitoring required indication is included in the message of step 209 when an energy monitoring required indication is included in the notification message of step 207.

In step 210, when the AMF receives the message of step 209, the AMF may change a network slice so that the dedicated S-NSSAI is used for the UE, instead of the S-NSSAI.

When the message of step 209 includes the time information, the AMF may start a timer configured to an expiration time included in the time information.

In step 211, when a UE that does not perform change to a dedicated DNN yet exists among the UEs that use the S-NSSAIs received in step 207, the PCF may transmit, to the AMF, a message (or Npcf_AMPolicyControl_UpdateNotify message) for changing to the dedicated DNN determined/allocated in step 208.

The message of step 211 may include at least one from among the following information.

AM policy association ID includes an identifier of an AM policy.

DNN is a network slice identifier to be changed, and includes an S-NSSAI for a service including UP requirements.

Alternative DNN is an alternative network slice identifier, and includes a dedicated S-NSSAI allocated for a service including UP requirements.

Time information concerning when a policy needs to be applied to a service is included in the notification message of step 207. The corresponding time information may be transmitted in the form of a timer.

Energy monitoring required indication is included in the message of step 211 when an energy monitoring required indication is included in the notification message of step 207.

In step 212, when the AMF receives the message of step 211, the AMF may perform DNN replacement so that the dedicated DNN is used for the UE, instead of the DNN indicating the service received in step 207.

When the message of step 211 includes the time information, the AMF may start a timer configured to an expiration time included in the time information.

In addition, the AMF may transmit an SM context update or release message to an SMF and may release a PDU session that uses the DNN indicating the service received in step 207. In this instance, the SMF may provide, to the UE, a PDU session command for PDU session release and reconfiguration.

When the DNN indicating the service received in step 207 is included in the PDU session establishment request message received from the UE, the AMF may change the DNN to the dedicated DNN and may include the dedicated DNN to a PDU session response message to be transmitted to the UE.

In step 213, when a dedicated UP indication is included in the received notification message of step 207, and when a dedicated S-NSSAI and/or dedicated DNN, which is currently being used, is newly allocated for the S-NSSAI and/or DNN (i.e., the corresponding service) included in the notification message of step 207, the PCF may transmit a message (or Nudr_Create/Update message) for storing the corresponding information to the UDR.

In step 214, when the timer that starts in step 209 expires, the PCF may transmit, to the AMF, a message (or Npcf_AMPolicyControl_UpdateNotify message) for updating so that a previous/existing S-NSSAI/DNN is to be reused for the UE that uses the service corresponding to the dedicated S-NSSAI and/or dedicated DNN.

In step 215, when the timer that starts in step 210 or 212 expires, or when the AMF receives a message from the PCF in step 214, the AMF may transmit a message, to the UE, UPF, and RAN, so that the existing S-NSSAI and/or DNN is to be used for the UE that uses the service corresponding to the dedicated S-NSSAI and/or dedicated DNN.

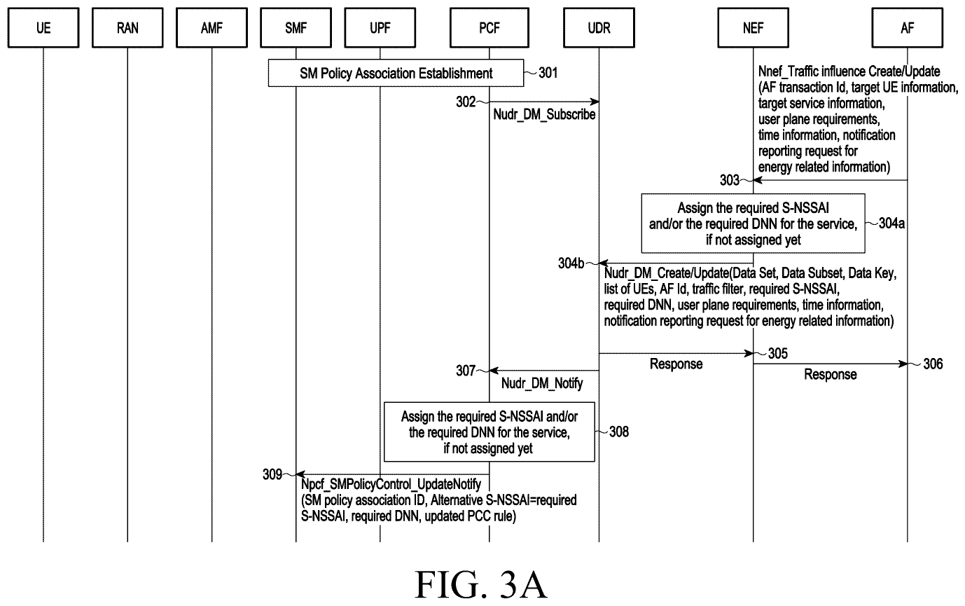

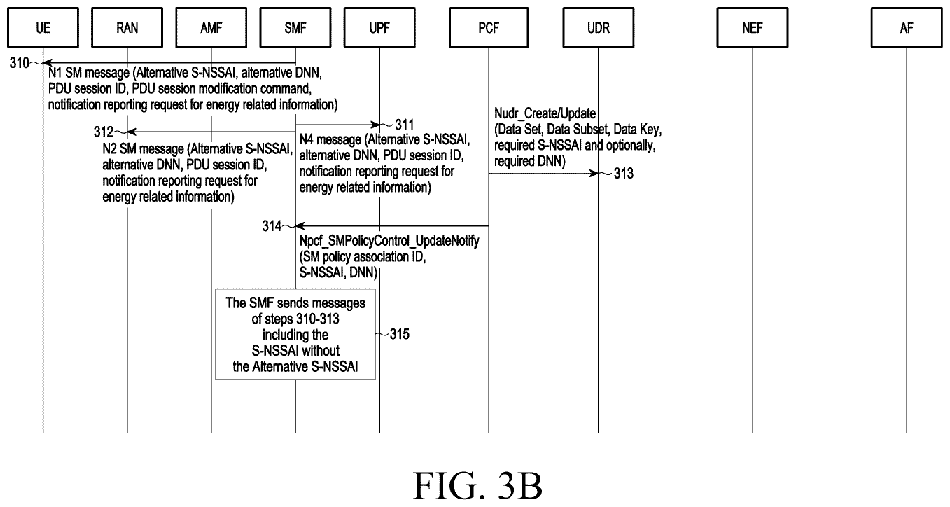

FIGS. 3A and 3B illustrate a procedure that selects/allocates/determines a network supporting energy control in a wireless communication system according to an embodiment. The procedures of FIG. 3A and FIG. 3B include a method in which an AF provides, to an SMF via a PCF, UP requirements associated with a PDU session(s) for a service requiring energy control.

Referring to FIG. 3A, in step 301, the SMF may perform SM policy association establishment with the PCF. Via the policy association establishment, the SMF may obtain, from the PCF, session management related policies (SM policy) associated with a PDU session of a UE.

In step 302, the PCF may transmit, to a UDR, a subscription request message for subscribing (subscription) to application data stored in the UDR in association with a predetermined service (or application) or a predetermined UE(s). The subscription request message may include at least one piece of information from among a data set, a data subset, and a data key as described below, and each information may be configured as follows.

A data key may be configured as an S-NSSAI and/or DNN indicating a predetermined service, or may be configured as identifier information associated with a UE(s) that uses a predetermined service (internal group identifier or SUPI or a PLMN ID of inbound roamers).

A data set may be configured as application data.

A data subset may be configured as AF traffic influence information.

A data key may be configured as an S-NSSAI and DNN and/or internal group identifier or SUPI or PLMN ID of inbound roamers or any UE.

In step 303, the AF may transmit, to an NEF, a message including requirement information associated with a UP for a UE(s) that uses a predetermined service (or application) or a predetermined UE(s). The message (or Nnef_Traffic influence Create/Update message) including the requirement (request) information may include at least one from among the following information.

AF transaction Id indicates a transaction identifier for the corresponding request.

Target UE information includes information indicating a UE(s) to which the corresponding request is to be applied. The corresponding information may include at least one from among a GPSI(s), SUPI(s), external group identifier, internal group identifier, PLMN ID, and any UE.

Target service information includes information indicating a service (or application) to which the corresponding request is to be applied. The information indicating the service (or application) that is subjected to the application may include one or more from among an external application identifier, an ASP ID, an AF Id, an S-NSSAI/DNN, or a traffic filter.

UP requirements are associated with an object and may include a dedicated UP required indication (or energy monitoring required indication), or an energy saving required indication. The dedicated UP required indication (or energy monitoring required indication) may be an indicator requesting that a corresponding traffic be serviced by a UP (i.e., dedicated UP) that uses the corresponding traffic. The energy saving required indication may include an indicator indicating that a corresponding traffic is to be subjected to energy saving. Alternatively, the dedicated UP required indication (or energy monitoring required indication), together with the energy saving required indication, may be included in the UP requirements.

Time information concerning when the information included in the requirements is to be applied.

Notification reporting request for energy related information includes address information (e.g., FQDN, IP address/port number, or the like) for receiving a notification message associated with energy-related information. The corresponding address may include an address of the NEF or an address of the AF.

When the NEF is configured to allocate a required S-NSSAI and/or required DNN (or dedicated S-NSSAI and/or dedicated DNN), the NEF may allocate the required S-NSSAI/required DNN for a service identified by an AF ID with UP requirements or an ASP ID or an S-NSSAI/DNN in step 304a. In this instance, operation 308 described below may be omitted.

When the PCF is configured to allocate a required S-NSSAI and/or required DNN (or dedicated S-NSSAI and/or dedicated DNN), the PCF may allocate the required S-NSSAI/required DNN for a service identified by an AF ID with UP requirements or an ASP ID or an S-NSSAI/DNN in step 308. In this instance, operation 304a may be omitted.

When the PCF is configured to allocate the required S-NSSAI and/or required DNN, the required DNN and/or required S-NSSAI may not be included in the message (or Nudr_DM_Create/Update message) that the NEF transmits to the UDR in step 304b.

When UP requirements are included in the message received in step 303, and when a required S-NSSAI and/or required DNN (or dedicated S-NSSAI and/or dedicated DNN) that satisfies the requirements is not allocated yet for the AF ID or ASP ID or S-NSSAIDNN included in the message of step 303, the NEF may allocate a required S-NSSAI and/or required DNN in step 304a and may store the required S-NSSAI and/or required DNN in the UDR.

When a dedicated UP indication is included in the UP requirements received in step 303, and when a required S-NSSAI and/or required DNN that satisfies the requirements is not allocated for the AF ID or ASP ID or S-NSSAI/DNN included in the message of step 303, the NEF may allocate, as the required S-NSSAI, one of dedicated S-NSSAI(s) yet to be allocated, to other service(s) or as the required DNN.

When an energy monitoring required indication is included in the UP requirements received in step 303, and when a required S-NSSAI and/or required DNN that satisfies the requirements is not allocated for the AF ID or ASP ID or S-NSSAI/DNN included in the message of step 303, the NEF may allocate, as the required S-NSSAI, one of dedicated S-NSSAI(s) yet to be allocated to other service(s). One of the dedicated DNN(s) yet to be allocated to other service(s) may be allocated as the required DNN.

When an energy saving required indication is included in the UP requirements received in step 303, and a required S-NSSAI and/or required DNN that satisfies the requirements is not allocated for the AF ID, ASP ID, or S-NSSAI/DNN included in the message of step 303 (e.g., when an S-NSSAI that supports energy saving or energy control and/or a DNN that supports energy saving or energy control is yet to be allocated), the NEF may allocate, as the required S-NSSAI, one of S-NSSAI(s) supporting energy control or energy saving. In addition, the NEF may allocate, as the required DNN, one of DNN(s) supporting energy control or energy saving.

When the NEF receives the message of step 303 from the AF and allocates the required S-NSSAI and/or required DNN, the NEF may transmit, to the UDR, a message (or Nudr_DM_Create/Update message) including at least one from among the following information to store, in the UDR, the information included in the request message received from the AF in step 304b. The message of step 304b may include at least one from among a data set, a data subset, a data key, and information to be stored for the corresponding key, and each information may be configured as follows. For information of which a description is omitted among the following information, refer to a description of the same information included in the above-described message(s).
A data set may be configured as application data.
A data subset may be configured as AF traffic influence information.
A data key may be configured as an S-NSSAI and DNN and/or internal group identifier or SUPI or PLMN ID of inbound roamers or any UE (or a data Key=AF transaction ID).
A data Key=AF Transaction Internal ID, and/or Internal Group Identifier(s) and/or Subscriber Category(s) or SUPI,
AF Id
Target service information (traffic filter)
UP requirements
Required S-NSSAI
Required DNN
Time information
Notification reporting request for energy related information

In step 305, when the UDR receives the message of step 304b and successfully stores the same, the UDR may transmit a response message to the NEF.

In step 306, when the NEF receives, from the UDR, the response message of step 305, including a processing result associated with the request message of step 304b, the NEF may transmit a response message including the processing result to the NEF in response to step 303. In step 307, when a PCF(s) that subscribes to updated application data, AF traffic influence information exists, the UDR may transmit a message (or Nudr_DM_Notify message) notifying the existence to the corresponding PCF(s). The message of step 307 may include parameters (information(s)) (or newly stored parameters) changed/configured in step 304b.

In step 308, when UP requirements are included in the notification message received in step 307, and when a required S-NSSAI and/or required DNN (or dedicated S-NSSAI, dedicated DNN) that satisfies the requirements is yet to be allocated for the AF ID or ASP ID or S-NSSAI/DNN included in the message of step 307 (that is, if the required S-NSSAI and/or the required DNN for the service does not assigned yet), the PCF may allocate a required S-NSSAI and/or required DNN and may store the required S-NSSAI and/or required DNN in the UDR in step 313, which will be described below.

Although not illustrated in FIG. 2A, the PCF may perform signaling with the UDR and may identify whether the dedicated S-NSSAI and/or dedicated DNN exist. When a dedicated S-NSSAI and/or dedicated DNN, allocated previously, exists, the PCF may use the previously allocated dedicated S-NSSAI and/or dedicated DNN.

In step 308, when UP requirements are included in the message received in step 307, and when a required S-NSSAI and/or required DNN (or dedicated S-NSSAI, dedicated DNN) that satisfies the requirements is yet to be allocated for the AF ID or ASP ID or S-NSSAI/DNN included in the message of step 307, the PCF may allocate a required S-NSSAI/required DNN and may store the required S-NSSAI/required DNN in the UDR.

In step 308, when a dedicated UP indication is included in the UP requirements received in step 307, and when a required S-NSSAI and/or required DNN that satisfies the requirements is not allocated for the AF ID or ASP ID or S-NSSAI/DNN included in the message of step 307, the PCF may allocate, as the required S-NSSAI, one of dedicated S-NSSAI(s) yet to be allocated to other service(s). One of a dedicated DNN(s) yet to be allocated to other service(s) may be allocated as the required DNN.

In step 308, when an energy monitoring required indication is included in the UP requirements received in step 307, and when a required S-NSSAI and/or required DNN that satisfies the requirements is not allocated for the AF ID or ASP ID or S-NSSAI/DNN included in the message of step 307, the PCF may allocate, as the required S-NSSAI, one of dedicated S-NSSAI(s) yet to be allocated to other service(s). One of a dedicated DNN(s) yet to be allocated to other service(s) may be allocated as the required DNN.

In step 308, when an energy saving required indication is included in the UP requirements received in step 307, and when a required S-NSSAI and/or required DNN that satisfies the requirements is not allocated for the AF ID, ASP ID, or S-NSSAI/DNN included in the message of step 307 (e.g., when it is different from an S-NSSAI that supports energy saving or energy control and/or a DNN that supports energy saving or energy control), the PCF may allocate, as the required S-NSSAI, one of S-NSSAI(s) supporting energy control or energy saving. In addition, one of DNN(s) supporting energy control or energy saving may be allocated as the required DNN.

When a PDU session(s) that is not yet using a required S-NSSAI exists among PDU session(s) that is using/providing the corresponding service, the PCF may perform a procedure for changing the S-NSSAI of the corresponding PDU session(s) to the required S-NSSAI.

In step 309, when a PDU session(s) that has yet to change to the dedicated S-NSSAI exists among the PDU session(s) that use the S-NSSAI received in step 307, the PCF may transmit, to the SMF, a message (or Npcf_SMPolicyControl_UpdateNotify message) for changing to the dedicated S-NSSAI determined/allocated in step 308.

When the message of step 307 includes the time information, the PCF may start a timer configured to an expiration time included in the time information.

At least one of energy monitoring required indication and a notification reporting request for energy related information may be included in a PCC rule in the message of step 309, and may be transmitted to the SMF.

The message of step 309 may include at least one from among the following information.

SM policy association ID: includes an identifier of an SM policy.

S-NSSAI: is a network slice identifier to be changed, and includes an S-NSSAI associated with a service included in the AF request together with UP requirements.

Alternative S-NSSAI: is an alternative network slice identifier, and includes a required S-NSSAI allocated to a service with UP requirements.

Time information: includes time information when the time information at which a policy for a service needs to be applied is included in the notification message of step 307. The corresponding time information may be transmitted in the form of a timer.

Energy monitoring required indication is included in the message of step 309 when an energy monitoring required indication is included in the notification message of step 307.

Notification reporting request for energy related information is included in the message of step 309 when a notification reporting request for energy related information is included in the notification message of step 307.

Referring to FIG. 3B, in step 310, when an alternative S-NSSAI and/or alternative DNN is included in the message of step 309, the SMF may respectively change a network slice and/or DNN to an alternative S-NSSAI and/or alternative DNN for a PDU session. The changing process may include operations 310 to 312. The alternative S-NSSAI and/or alternative DNN may be the required S-NSSAI and/or required DNN (or dedicated S-NSSAI and/or dedicated DNN).

When the time information is included in the message of step 309, a timer may start from the point in time at which changing to the alternative S-NSSAI and/or alternative DNN is performed for the PDU session.

When the alternative S-NSSAI is included in the message of step 309, the SMF may transmit, to a UE via an AMF and RAN, an N1 message indicating that the alternative S-NSSAI needs to be used for the PDU session, instead of the existing associated S-NSSAI.

When the alternative DNN is included in the message of step 309, the SMF may transmit, to the UE via the AMF and RAN, an N1 message indicating that the alternative DNN needs to be used for the PDU session, instead of the existing associated DNN.

The message (or N1 SM message) of step 310 may include at least one from among an alternative S-NSSAI, alternative DNN, PDU session ID, PDU session modification command, notification reporting request for energy related information (i.e., an NEF address or AF address as an address for receiving energy related information).

When the UE receives the alternative S-NSSAI, PDU session ID, or PDU session modification command (or PDU session release command) via the message of step 310, the UE may change the S-NSSAI of the PDU session to the alternative S-NSSAI.

When the UE receives the alternative DNN, PDU session ID, or PDU session modification command (or PDU session release command) via the message of step 310, the UE may change the DNN of the PDU session to the alternative DNN.

When the UE receives the notification reporting request for energy related information via the message of step 310, the UE may transmit a notification message including energy related information (e.g., energy consumption, energy efficiency, or the like) associated with the corresponding PDU session of the UE to an address (e.g., NEF address, AF address, or AS address) included in the notification reporting request for energy related information.

In step 311, when the alternative S-NSSAI is included in the message of step 309, the SMF may transmit, to an UPF, an N4 message indicating that the alternative S-NSSAI needs to be used for the PDU session, instead of the existing associated S-NSSAI.

When the alternative DNN is included in the message of step 309, the SMF may transmit, to the UPF, an N4 message indicating that the alternative DNN needs to be used for the PDU session, instead of the existing associated DNN.

The message of step 311 may include at least one from among an alternative S-NSSAI, alternative DNN, PDU session ID (or N4 session ID), notification reporting request for energy related information (i.e., an NEF address or AF address as an address for receiving energy related information).

In step 311, when the UPF receives the alternative S-NSSAI, PDU session ID (or N4 session ID), the UPF may change the S-NSSAI of the PDU session to the alternative S-NSSAI.

When the UPF receives the alternative DNN, PDU session ID (or N4 session ID), the UPF may change the DNN of the PDU session to the alternative DNN.

When the UPF receives the notification reporting request for energy related information, the UPF may transmit a notification message including energy related information (e.g., energy consumption, energy efficiency, or the like) associated with the corresponding PDU session of the UPF to an address (e.g., NEF address, AF address, or AS address) included in the notification reporting request for energy related information.

In step 312, when the alternative S-NSSAI is included in the message of step 309, the SMF may transmit, to the RAN via the AMF, an N2 SM message indicating that the alternative S-NSSAI needs to be used for the PDU session, instead of the existing associated S-NSSAI.

When the alternative DNN is included in the message of step 309, the SMF may transmit, to the RAN via the AMF, an N2 SM message indicating that the alternative DNN needs to be used for the PDU session, instead of the existing associated DNN.

The message of step 312 may include at least one from among an alternative S-NSSAI, alternative DNN, PDU session ID, notification reporting request for energy related information (i.e., an NEF address or AF address as an address for receiving energy related information).

In step 312, when the RAN receives the alternative S-NSSAI, PDU session ID, the RAN may change the S-NSSAI of the PDU session to the alternative S-NSSAI.

When the RAN receives the alternative DNN, PDU session ID, the RAN may change the DNN of the PDU session to the alternative DNN.

When the RAN receives the notification reporting request for energy related information, the RAN may transmit a notification message including energy related information (e.g., energy consumption, energy efficiency, or the like) associated with the corresponding PDU session of the RAN to an address (e.g., NEF address, AF address, or AS address) included in the notification reporting request for energy related information.

In step 313, when a required S-NSSAI and/or required DNN is newly allocated for the S-NSSAI and/or DNN (i.e., the corresponding service) included in the notification message of step 307, the PCF may transmit a message (or Nudr_Create/Update message) for storing the corresponding information in the UDR.

In step 314, when the timer that starts in step 309 expires, the PCF may transmit, to the SMF, a message (or Npcf_SMPolicyControl_UpdateNotify) for updating so that a previous S-NSSAI/DNN is to be used for the PDU session.

In step 315, when a timer that starts in step 310 expires or when a message is received from the PCF in step 314, the SMF may transmit, to the UE, UPF, and RAN, a message indicating that the existing S-NSSAI and/or DNN needs to be used for the PDU session.

In step 315, when the UE receives the message of step 310 excluding an alternative S-NSSAI/alternative DNN (or including the existing S-NSSAI/DNN instead of an alternative S-NSSAI/alternative DNN), the UE may change the S-NSSAI for the PDU session to the existing S-NSSAI and/or may change the DNN for the PDU session to the existing DNN.

In step 315, when the UPF receives the message of step 311 excluding an alternative S-NSSAI/alternative DNN (or including the existing S-NSSAI/DNN instead of an alternative S-NSSAI/alternative DNN), the UPF may change the S-NSSAI for the PDU session to the existing S-NSSAI and/or may change the DNN for the PDU session to the existing DNN.

In step 315, when the RAN receives the message of step 312 excluding the alternative S-NSSAI/alternative DNN (or including the existing S-NSSAI/DNN instead of the alternative S-NSSAI/alternative DNN), the RAN may change the S-NSSAI for the PDU session to the existing S-NSSAI and/or may change the DNN for the PDU session to the existing DNN.

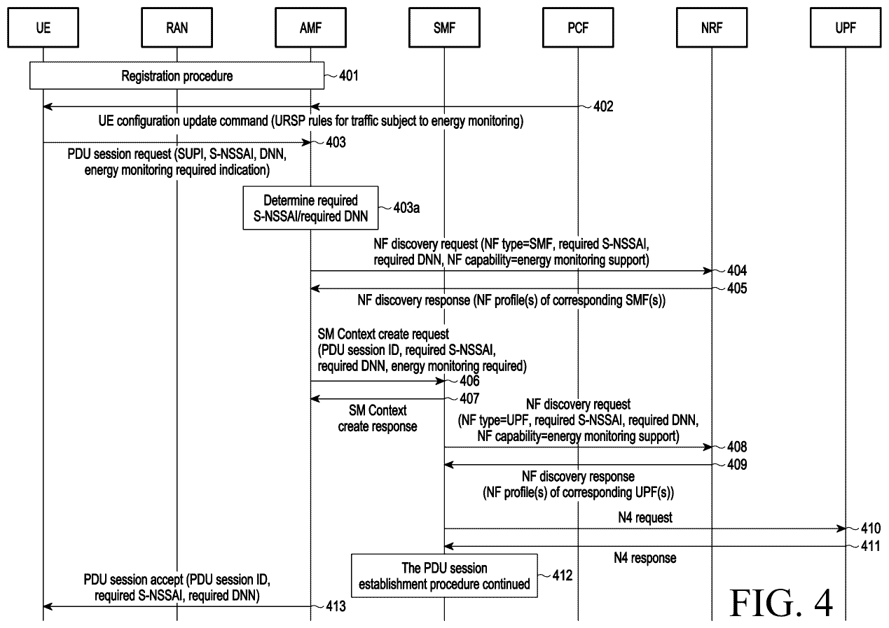

FIG. 4 illustrates an energy monitoring session request method based on UE configuration information in a wireless communication system that supports energy control according to an embodiment.

Referring to FIG. 4, in step 401, a UE may perform a registration procedure via an AMF.

In step 402, a PCF may determine a policy for the registered UE. The UE policy may include a UE route selection policy (URSP) rule(s) including a traffic descriptor and a route selection descriptor. The PCF may generate the URSP rule for traffic to be subjected to energy monitoring or energy control. In this instance, the traffic descriptor may include traffic identification information (e.g., destination IP address, port number, protocol, a domain name of a server) associated with traffic that is subjected to energy monitoring or energy control. The route selection descriptor (RSD) may include information indicating that a UP that supports energy monitoring or control is needed. The information indicating that the UP that supports energy monitoring or control is needed may include a separate indicator (e.g., energy monitoring required indication) or an S-NSSAI used as an request indicator for re-assignment (i.e., when the corresponding S-NSSAI is received from the UE, a network determines that slice allocation is requested due to an energy monitoring request or the like).

In step 402, the PCF may transmit, to the UE via the AMF and RAN, a message (or UE configuration update command) including the URSP rule(s) that includes configuration information associated with the traffic that is subjected to energy control. The UE may store the information included in the message.

In step 403, when traffic to be subjected to energy control occurs, the UE may transmit, to the AMF, a PDU session establishment request message according to the matched URSP rule.

When the matched URSP rule includes information indicating a need of a UP supporting energy monitoring or control in the form of a separate indicator, the PDU session establishment request message may include at least one from among the following information.
SUPI is an identifier of a UE.
S-NSSAI is included in an RSD of a URSP rule.
DNN is included in an RSD of a URSP rule.
Energy monitoring required indication when included in an RSD of the matched URSP rule.

Alternatively, when the matched URSP rule includes information indicating that a need of a UP supporting energy monitoring or control in the form of a separate indicator, the PDU session establishment request message may include at least one from among the following information.

SUPI is an identifier of a UE.

S-NSSAI used as a request indicator for re-assignment is an S-NSSAI included in an RSD of the matched URSP rule. The corresponding S-NSSAI may be configured as an S-NSSAI used as a request indicator for re-assignment.

DNN is included in an RSD of the matched URSP rule.

In step 403a, when an energy monitoring required indication is included in the message of step 403, or when the S-NSSAI included in the message of step 403 is an S-NSSAI corresponding to an energy monitoring request, the AMF may determine a corresponding PDU session as a PDU session that supports energy monitoring.

In addition, the AMF may allocate a required S-NSSAI (e.g., an S-NSSAI that supports energy monitoring), instead of the S-NSSAI received in step 403. When an energy monitoring required indication is included in the message of step 403, or when the DNN included in the message of step 403 is a DNN corresponding to an energy monitoring request, the AMF may allocate a required DNN (e.g., DNN that supports energy monitoring), instead of the DNN received in step 403.

In step 404, when the AMF receives a PDU session establishment request of step 403 from the UE, and the corresponding PDU session is a PDU session that supports energy monitoring, the AMF may include at least one from among the S-NSSAI or DNN allocated/determined in step 403a and an NF capability including energy monitoring support, in a message (or NF discovery request message) transmitted to an NRF to obtain an address of an SMF.

In step 405, the NRF may transmit, to the AMF, a response message (or NF discovery response message) including an NF profile(s) of an SMF(s) that satisfies a condition included in the message of step 404 received from the AMF.

When energy monitoring support is included in the message of step 404 received from the AMF, the NRF may transmit, to the AMF, a response message including an NF profile(s) of an SMF that supports energy monitoring in step 405.

In step 406, the AMF may select one of the NF profiles received in step 405 and transmit an SM context create request message to the corresponding SMF. The SM context create request message may include a PDU session ID, the S-NSSAIDNN determined/allocated in step 403a, and an energy monitoring required indicator.

In step 407, when the SMF receives the message of step 406, the SMF may transmit a response message (or SM context create response) including success or failure to the AMF.

In step 408, when an energy monitoring required indicator is included in the message of step 406, or when the S-NSSAI and/or DNN included in the message of step 406 is an S-NSSAI and/or DNN for energy monitoring, the SMF may include an S-NSSAI, DNN, and an NF capability including energy monitoring support in a message (or NF discovery request) that is transmitted to the NRF to obtain an address of a UPF.

In step 409, the NRF may include NF profile(s) of UPF(s) that satisfy a condition included in the message of step 408 received from the SMF, in a response message (or NF discovery response). When the message of step 408 received from the SMF includes energy monitoring support, the NRF may include an NF profile of a UPF that supports energy monitoring in the response message.

In step 410, the SMF may select one of the NF profile(s) received in step 409 and may transmit an N4 session establishment request (or N4 request) to the corresponding UPF. The message of step 410 may include a PDU session ID, a required S-NSSAI and/or required DNN, and an energy monitoring required indicator.

In step 411, when the UPF receives the message of step 410, the UPF may transmit a response message (or N4 response) including success or failure to the SMF.

In step 412, the remaining PDU session establishment procedure may be performed.

In step 413, the AMF may transmit a PDU session accept message to the UE via the RAN. The PDU session accept message may include the required S-NSSAI and/or required DNN determined/allocated in step 403a. The required S-NSSAI and/or required DNN may be different from the S-NSSAI and/or DNN transmitted by the UE in step 403.

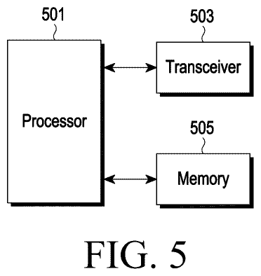

FIG. 5 illustrates a structure of a network entity in a wireless communication system according to an embodiment.

The network entity in FIG. 5 may be at least one of network entities described in the embodiments of FIGS. 1 to 4.

Referring to FIG. 5, the network entity may include a processor 501, a transceiver 503, and memory 505. The processor 501, the transceiver 503, and the memory 505 of the network entity may be operated according to the above-described communication methods of the network entity as described in the embodiments of FIGS. 1 to 4. However, components of the network entity are not limited to the above-described example. For example, the network entity may include a larger or smaller number of components than the above-described components. In addition, the processor 501, the transceiver 503, and the memory 505 may be implemented in the form of a single chip.

The transceiver 503 refers to a network entity receiver and a network entity transmitter as a whole, and may transmit/receive signals with UEs or other network entities. The transmitted/received signals may include at least one of control information and data. To this end, the transceiver 503 may include wired/wireless transceivers, and may include various components for transmitting/receiving signals. The transceiver 503 may receive signals via a specified communication interface, output same to the processor 501, and transmit signals output from the processor 501. In addition, if the network entity in FIG. 5 is a UE, the transceiver 503 may include an RF transmitter configured to up-convert and amplify the frequency of transmitted signals, and an RF receiver configured to low-noise-amplify received signals and down-convert the frequency thereof. Furthermore, the transceiver 503 may receive communication signals, output same to the processor 501, and transmit signals output from the processor 501 to UEs or network entities through a network. The memory 505 may store programs and data necessary for the operations of the network entity according to at least one of the embodiments of FIGS. 1 to 4. In addition, the memory 505 may store control information or data included in signals acquired by the network entity. The memory 505 may include storage media such as a read only memory (ROM), a random access memory (RAM), a hard disk, a CD-ROM, and a digital versatile disc (DVD), or a combination of storage media.

The processor 501 may control a series of processes such that the network entity can operate according to at least one of the embodiments of FIGS. 1 to 4. The processor 501 may include at least one processor. Methods disclosed in the claims and/or methods according to the embodiments described in the specification of the disclosure may be implemented by hardware, software, or a combination of hardware and software. When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a ROM, an electrically erasable programmable read only memory (EEPROM), a magnetic disc storage device, a compact disc-ROM (CD-ROM), DVDs, or other type optical storage devices, or a magnetic cassette. Alternatively, any combination of some or all of them may form a memory in which the program is stored. In addition, a plurality of such memories may be included in the electronic device. Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

Herein, each block of the flowchart illustrations, and combinations of blocks in the flowchart illustrations, can be implemented by computer program instructions.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

Herein, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” may include one or more processors.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a policy control function (PCF) in a wireless communication system that supports energy control, the method comprising:
receiving, from a unified data repository (UDR), a first message including user plane (UP) requirement information related to the energy control and provided from an application function (AF);
identifying whether indication information related to the energy control is included in the UP requirement information;
in case that the indication information is included in the UP requirement information, identifying whether network slice related information required for the energy control for a user equipment (UE) that uses a service exists; and
in case that the network slice related information does not exist, obtaining the network slice related information required for the energy control for the service.

2. The method of claim 1,
wherein the indication information comprises at least one of a dedicated UP required indication, an energy monitoring required indication, and an energy saving required indication.

3. The method of claim 1,
wherein the network slice related information comprises at least one of single-network slice selection assistance information (S-NSSAI) and a data network name (DNN) that are required for the energy control.

4. The method of claim 3,
wherein obtaining the network slice related information further comprises allocating, by the PCF, at least one of the required S-NSSAI and the required DNN for the energy control.

5. The method of claim 3,
wherein obtaining the network slice related information comprises receiving, by the PCF, at least one of the required S-NSSAI and the required DNN via performing signaling with the UDR.

6. The method of claim 1,
wherein the first message comprises time information at which information included in the UP requirement information is to be applied to the service.

7. The method of claim 1, further comprising transmitting a second message including the network slice related information required for the energy control to an access and mobility management function (AMF) that manages mobility of the UE or a session management function (SMF) that manages a PDU session of the UE.

8. A policy control function (PCF) in a wireless communication system that supports energy control, the PCF comprising:
a transceiver; and
a processor configured to
receive, from a unified data repository (UDR) via the transceiver, a first message including user plane (UP) requirement information related to the energy control and provided from an application function (AF),
identify whether indication information related to the energy control is included in the UP requirement information,
in case that the indication information is included in the UP requirement information, identify whether network slice related information required for the energy control for a user equipment (UE) that uses a service exists, and
in case that the network slice related information does not exist, obtain the network slice related information required for the energy control for the service.

9. The PCF of claim 8,
wherein the indication information comprises at least one of a dedicated UP required indication, an energy monitoring required indication, and an energy saving required indication.

10. The PCF of claim 8,
wherein the network slice related information comprises at least one of a single-network slice selection assistance information (S-NSSAI) and a data network name (DNN) that are required for the energy control.

11. The PCF of claim 10,
wherein the processor is further configured to, in case that the network slice related information does not exist, allocate at least one of the required S-NSSAI and the required DNN for the energy control.

12. The PCF of claim 11,
wherein the processor is further configured to receive at least one of the required S-NSSAI and the required DNN via performing signaling with the UDR.

13. The PCF of claim 8,
wherein the first message comprises time information at which information included in the UP requirement information is to be applied to the service.

14. The PCF of claim 8,
wherein the processor is further configured to transmit, via the transceiver, a second message including the network slice related information required for the energy control to an access and mobility management function (AMF) that manages mobility of the UE or a session management function (SFM) that manages a PDU session of the UE.
